(19) United States
(12) Patent Application Publication
(10) Pub. No.: US 2017/0283216 A1
(43) Pub. Date: Oct. 5, 2017

(54) CONDITION SENSING ARRANGEMENT FOR ELEVATOR SYSTEM BRAKE ASSEMBLY AND METHOD

(71) Applicant: Otis Elevator Company, Farmington, CT (US)

(72) Inventors: Daryl J. Marvin, Farmington, CT (US); Craig Drew Bogli, Deep River, CT (US); Arthur T. Grondine, Vernon, CT (US); Guohong Hu, Farmington, CT (US)

(21) Appl. No.: 15/088,851

(22) Filed: Apr. 1, 2016

(51) Int. Cl. B66B 5/18; B66B 5/04; B66B 5/00

(52) U.S. Cl. CPC B66B 5/18; B66B 5/0031; B66B 5/044

(57) ABSTRACT

A brake assembly for an elevator system is provided and includes a guide rail configured to guide movement of an elevator car. Also included is a safety brake operatively coupled to the elevator car and having a brake surface configured to frictionally engage the guide rail. Further included is a safety brake actuation mechanism operatively coupled to the safety brake and configured to actuate the safety brake to a braking position. The mechanism includes a first sensing device disposed on a first side of the guide rail to detect a first condition reading of the elevator car relative to the guide rail. The mechanism also includes a second sensing device disposed on a second, opposite side of the guide rail to detect a second condition reading of the elevator car relative to the guide rail, the first and second condition readings collectively analyzed to determine an overall condition reading.

### BACKGROUND OF THE INVENTION

The embodiments herein relate to elevator braking systems and, more particularly, to a condition sensing arrangement for elevator braking systems, as well as a method of detecting an elevator condition.

Elevator braking systems may include a safety braking system configured to assist in braking a hoisted structure (e.g., elevator car) relative to a guide member, such as a guide rail, in the event the hoisted structure meets a predetermined speed or acceleration. Some braking systems include an electronic safety actuation device that relies on an optical speed sensing device to detect a car running speed relative to the guide rail. The optical speed sensing device has limitations and sensitivity related to distance variation between the sensor lens and the guide rail surface. In some cases, movement of the elevator car during travel results in front-to-back and side-to-side movement of varying degrees that increases and/or decreases the distance between the sensor lens and the guide rail surface, thereby introducing the possibility of less than optimal speed readings. A reliable speed measurement is desired.

### BRIEF DESCRIPTION OF THE INVENTION

According to one embodiment, a brake assembly for an elevator system is provided and includes a guide rail configured to guide movement of an elevator car. Also included is a safety brake operatively coupled to the elevator car and having a brake surface configured to frictionally engage the guide rail. Further included is a safety brake actuation mechanism operatively coupled to the safety brake and configured to actuate the safety brake to a braking position. The safety brake actuation mechanism includes a first sensing device disposed on a first side of the guide rail to detect a first condition reading of the elevator car relative to the guide rail. The mechanism also includes a second sensing device disposed on a second, opposite side of the guide rail to detect a second condition reading of the elevator car relative to the guide rail, the first condition reading and the second condition reading collectively analyzed to determine an overall condition reading.

In addition to one or more of the features described above, or as an alternative, further embodiments may include that the first condition reading and the second condition reading each comprise a speed reading of the elevator car relative to the guide rail.

In addition to one or more of the features described above, or as an alternative, further embodiments may include that the first condition reading and the second condition reading each comprise an acceleration reading of the elevator car relative to the guide rail.

In addition to one or more of the features described above, or as an alternative, further embodiments may include that the first sensing device and the second sensing device are vertically aligned with each other.

In addition to one or more of the features described above, or as an alternative, further embodiments may include that the first sensing device and the second sensing device are vertically offset from each other.

In addition to one or more of the features described above, or as an alternative, further embodiments may include that the first sensing device and the second sensing device are each optical sensors.

In addition to one or more of the features described above, or as an alternative, further embodiments may include a controller in operative communication with the first sensing device and the second sensing device, the controller determining the overall condition reading.

In addition to one or more of the features described above, or as an alternative, further embodiments may include that the safety brake actuation mechanism actuates the safety brake to the braking position when the controller determines the overall condition reading meets a predetermined condition.

In addition to one or more of the features described above, or as an alternative, further embodiments may include that the controller is in operative communication with at least one additional safety brake actuation mechanism to actuate at least one additional safety brake when the overall condition reading meets the predetermined condition.

In addition to one or more of the features described above, or as an alternative, further embodiments may include that the at least one additional safety brake actuation mechanism does not include a sensing device.

In addition to one or more of the features described above, or as an alternative, further embodiments may include that the first condition reading and the second condition reading averaged to determine the overall condition reading.

According to another embodiment, a method of detecting an elevator car speed is provided. The method includes obtaining a first speed reading with a first optical sensor disposed on a first side of a guide rail. The method also includes obtaining a second speed reading with a second optical sensor disposed on a second, opposite side of the guide rail. The method further includes collectively analyzing the first speed reading and the second speed reading to determine an overall speed reading of the elevator car relative to the guide rail.

In addition to one or more of the features described above, or as an alternative, further embodiments may include that the first optical sensor and the second optical sensor are each in operative communication with a controller, the controller determining the overall speed reading.

In addition to one or more of the features described above, or as an alternative, further embodiments may include that the first optical sensor and the second optical sensor are operatively coupled to a safety brake actuation mechanism of the elevator car, controller initiating movement of the safety brake actuation mechanism to actuate a safety brake when the overall speed reading meets a predetermined speed.

In addition to one or more of the features described above, or as an alternative, further embodiments may include that the controller is in operative communication with at least one additional safety brake actuation mechanism of the elevator car, the controller initiating movement of the at least one additional safety brake actuation mechanism when the overall speed reading meets the predetermined speed.

In addition to one or more of the features described above, or as an alternative, further embodiments may include that the first condition reading and the second condition reading are averaged to determine the overall condition reading.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a pair of brake assemblies for an elevator system having a safety brake and a safety brake actuation mechanism;

FIG. 2 is a plan view of the safety brake actuation mechanism and a guide rail;

FIG. 3 is a perspective view of the safety brake actuation mechanism according to an embodiment; and

FIG. 4 is a perspective view of the safety brake actuation mechanism according to another embodiment that includes two pairs of brake assemblies.

### DETAILED DESCRIPTION OF THE INVENTION

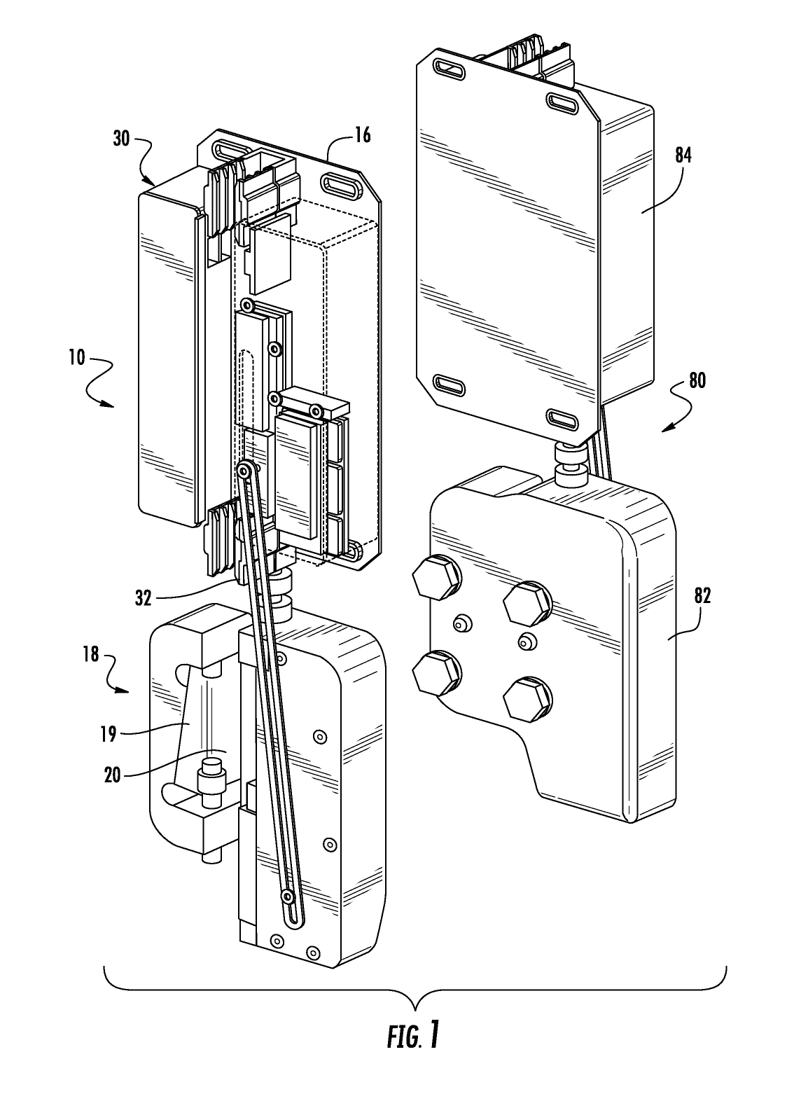

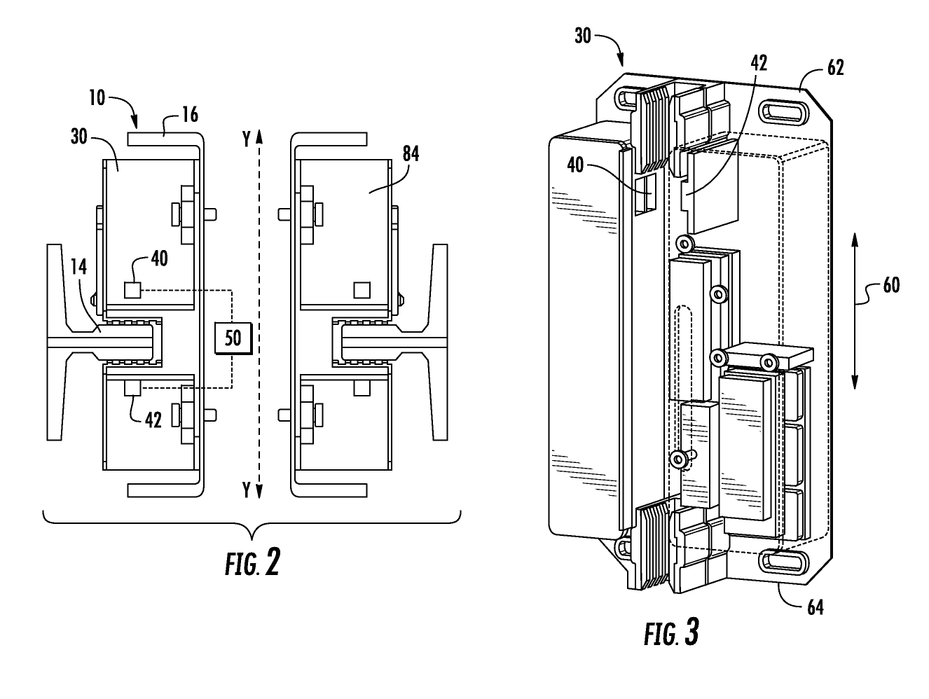

Referring to FIG. 1, a brake assembly 10 for an elevator system is illustrated. The embodiments described herein relate to an overall braking system that is operable to assist in braking (e.g., slowing or stopping movement) of an elevator car, relative to a guide rail 14 (FIG. 2) that is connected to a sidewall of an elevator car passage and is configured to guide the elevator car, typically in a vertical manner. The brake assembly 10 can be used with various types of elevator systems. For example, the embodiments described herein may be used with roped or ropeless elevator systems. In some embodiments, the brake assembly 10 is used on a counterweight.

The brake assembly 10 includes a mounting structure 16, such as an elevator car frame, and a safety brake 18. The safety brake 18 includes a brake pad 19 or a similar structure suitable for repeatable braking engagement with the guide rail 14 (FIG. 2). The mounting structure 16 is connected to the elevator car and the safety brake 18 is positioned on the mounting structure 16 in a manner that disposes the brake member 18 in proximity with the guide rail 14 (FIG. 2). The safety brake 18 includes at least one component, such as the brake pad 19, having a contact surface 20 that is operable to frictionally engage the guide rail 14 (FIG. 2).

The safety brake 18 is operable between a non-braking position and a braking position. The non-braking position is a position that the safety brake 18 is disposed in during normal operation of the elevator car. In particular, the safety brake 18 is not in contact with the guide rail 14 (FIG. 2) while in the non-braking position, and thus does not frictionally engage the guide rail 14 (FIG. 2). In the braking position, the frictional force between the contact surface 20 of the safety brake 18 and the guide rail 14 is sufficient to stop movement of the elevator car relative to the guide rail 14. Various triggering mechanisms or components may be employed to actuate the safety brake actuation mechanism 30. In the illustrated embodiment, a link member 32 is provided and is operatively coupled to the safety brake actuation mechanism 30 and the safety brake. Movement of the link member 32 triggers movement of the safety brake 18 from the non-braking position to the braking position.

In operation, an electronic sensing device and/or control system (not illustrated) is configured to monitor various parameters and conditions of the elevator car and to compare the monitored parameters and conditions to at least one predetermined condition. In one embodiment, the predetermined condition comprises speed and/or acceleration of the elevator car. In the event that the monitored condition (e.g., over-speed, over-acceleration, etc.) meets the predetermined condition, a safety brake actuation mechanism 30 is actuated to facilitate engagement of the safety brake 18 and the guide rail 14 (FIG. 2).

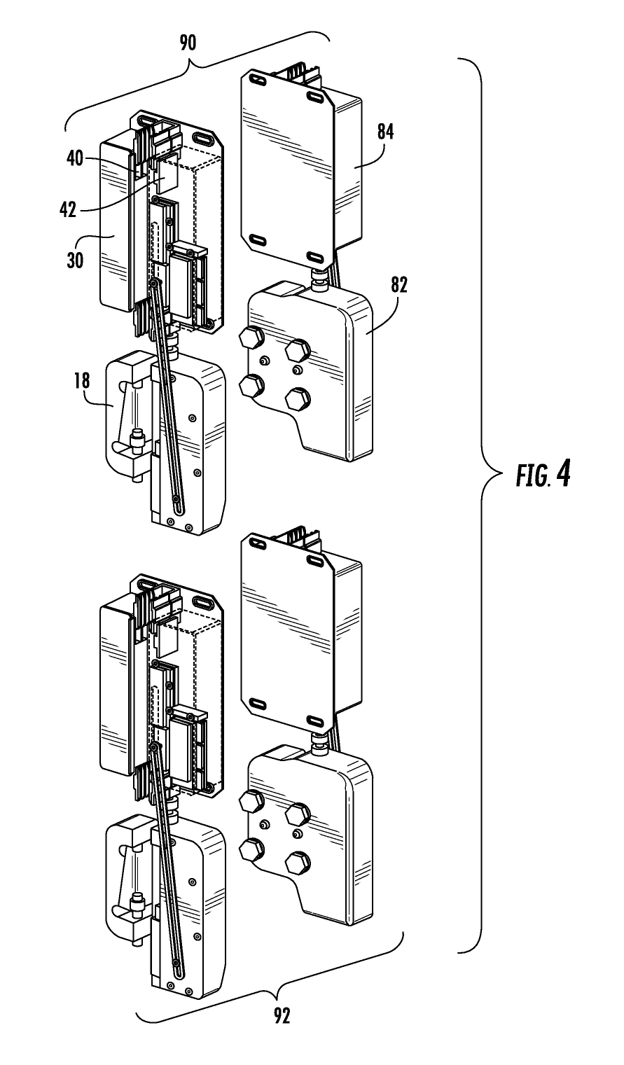

Referring now to FIGS. 2 and 3, the safety brake actuation mechanism 30 is illustrated in greater detail. The safety brake actuation mechanism 30 includes a first sensing device 40, such as a sensor that is configured to detect the speed or acceleration of the elevator car, relative to the guide rail 14. In some embodiments, the first sensing device 40 is an optical sensor, however any other type of sensor may be used including a laser-based sensor, an infra LED sensor, a sensor based on optical Doppler shift of laser light, a Doppler radar sensor, and a magnetic tape reader. The preceding list is merely illustrative and is not intended to be limiting. Although the first sensing device 40 is nominally positioned at a predetermined distance from the guide rail 14, it is possible that the distance between the guide rail 14 and a lens of the first sensing device 40 varies due to lateral movement of the elevator car during travel. Side-to-side or front-to-back movement of the elevator car may cause such variation which may result in variation in condition (e.g., speed or acceleration) measurements.

To provide more reliable condition measurements, a second sensing device 42 is operatively coupled to the safety brake actuation mechanism and disposed on an opposing side of the guide rail 14 relative to the first sensing device 40. The second sensing device 42 is an optical sensor in some embodiments and is potentially subjected to the same distance variations as those discussed above in connection with the first sensing device 42. However, the second sensing device 42 provides redundancy in condition (e.g., speed) sensing to enhance the reading reliability and to minimize the impact of sensing distance variation.

During lateral movement of the elevator car along axis Y-Y of FIG. 2, and thereby the safety brake actuation mechanism 30, the first sensing device 40 may deviate from a nominal position by a distance X relative to the rail. During such movement, the second sensing device 42 simultaneously also deviates from its nominal position by distance X, but in the opposite direction. In other words, as the first sensing device 40 moves away from the guide rail 14 to deviate from a nominal position by distance X, the second sensing device 42 moves closer to the guide rail 14 to deviate from its nominal position by distance X. Conversely, as the first sensing device 40 moves toward the guide rail 14 to deviate from a nominal position by distance X, the second sensing device 42 moves away from the guide rail 14 to deviate from its nominal position by distance X.

Since the above-described deviations are equal and opposite relative to each other, condition readings from the sensing devices 40, 42 are combined to provide an overall condition reading which may be relied upon as an actual condition (e.g., speed) reading. In particular, the first sensing device 40 provides a first condition reading and the second sensing device 42 provides a second condition reading. The first and second condition readings are combined to determine the overall condition reading. In some embodiments, the first and second sensing devices 40, 42 are in operative communication with a controller 50. The controller 50, upon receipt of the first and second condition readings, processes the readings to determine the overall condition reading. Upon detection of an overall condition reading that meets a predetermined condition (e.g., excessive speed and/or acceleration), the controller 50 provides an electronic command to the safety brake actuation mechanism 30 to actuate the safety brake to the braking position. In some embodiments, the first and second readings are averaged. In other embodiments, the readings are utilized in alternative mathematical functions to compare an output with the predetermined condition.

The safety brake actuation mechanism 30 extends along a direction 60 from a first end 62 to a second end 64. In some embodiments, the first sensing device 40 and the second sensing device 42 are vertically aligned relative to each other, such that they are positioned at a common location along direction 60. In other embodiments, the first sensing device 40 and the second sensing device 42 are vertically offset from each other, such that they are positioned at distinct locations along direction 60.

Referring again to FIGS. 1 and 2, in some embodiments a pair of brake assemblies, such as brake assembly 10 and additional brake assembly 80 may be included to be provided on opposing sides of the elevator car. Additional brake assembly 80 includes an additional safety brake 82 and additional safety brake actuation mechanism 84. In some embodiments, one or more sensing devices may be provided on the safety brake actuation mechanism 84. In other embodiments, the additional brake assembly 80 does not include its own sensing devices and is completely reliant on the readings of the first and second sensing devices 40, 42 that are located on a distinct safety brake actuation mechanism (i.e., safety brake actuation mechanism 30). In such an embodiment, the controller 50 is also in operative communication with the additional safety brake actuation mechanism 84 to command actuation of the additional safety brake 82 in the event of detection of an overall condition reading that meets a predetermined condition.

Referring to FIG. 4, another embodiment of the brake assembly arrangement is illustrated. In such an embodiment, yet additional brake assemblies may be included. For example, a first pair of brake assemblies 90 and a second pair of brake assemblies 92 may be provided along the elevator car. In some embodiments, only one safety brake actuation mechanism (e.g., safety brake actuation mechanism 30) includes sensing devices and all other safety brake actuation mechanisms are reliant on the condition readings generated from the sensing devices described above.

Advantageously, the sensor arrangement described herein provides improved system performance of condition (e.g., speed) sensing by minimizing the impact of sensing distance variation and enhances reliability with the redundant arrangement of sensing devices.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A brake assembly for an elevator system comprising:
a guide rail configured to guide movement of an elevator car;
a safety brake operatively coupled to the elevator car and having a brake surface configured to frictionally engage the guide rail; and
a safety brake actuation mechanism operatively coupled to the safety brake and configured to actuate the safety brake to a braking position, the safety brake actuation mechanism comprising:
a first sensing device disposed on a first side of the guide rail to detect a first condition reading of the elevator car relative to the guide rail; and
a second sensing device disposed on a second, opposite side of the guide rail to detect a second condition reading of the elevator car relative to the guide rail, the first condition reading and the second condition reading collectively analyzed to determine an overall condition reading.

2. The brake assembly of claim 1, wherein the first condition reading and the second condition reading each comprise a speed reading of the elevator car relative to the guide rail.

3. The brake assembly of claim 1, wherein the first condition reading and the second condition reading each comprise an acceleration reading of the elevator car relative to the guide rail.

4. The brake assembly of any of the preceding claims, wherein the first sensing device and the second sensing device are vertically aligned with each other.

5. The brake assembly of any of claims 1-3, wherein the first sensing device and the second sensing device are vertically offset from each other.

6. The brake assembly of any of the preceding claims, wherein the first sensing device and the second sensing device are each optical sensors.

7. The brake assembly of any of the preceding claims, further comprising a controller in operative communication with the first sensing device and the second sensing device, the controller determining the overall condition reading.

8. The brake assembly of claim 7, wherein the safety brake actuation mechanism actuates the safety brake to the braking position when the controller determines the overall condition reading meets a predetermined condition.

9. The brake assembly of claim 8, wherein the controller is in operative communication with at least one additional safety brake actuation mechanism to actuate at least one additional safety brake when the overall condition reading meets the predetermined condition.

10. The brake assembly of claim 9, wherein the at least one additional safety brake actuation mechanism does not include a sensing device.

11. The brake assembly of any of the preceding claims, wherein the first condition reading and the second condition reading averaged to determine the overall condition reading.

12. A method of detecting an elevator car speed comprising:
obtaining a first speed reading with a first optical sensor disposed on a first side of a guide rail;
obtaining a second speed reading with a second optical sensor disposed on a second, opposite side of the guide rail; and
collectively analyzing the first speed reading and the second speed reading to determine an overall speed reading of the elevator car relative to the guide rail.

13. The method of claim 12, wherein the first optical sensor and the second optical sensor are each in operative communication with a controller, the controller determining the overall speed reading.

14. The method of claim 13, wherein the first optical sensor and the second optical sensor are operatively coupled to a safety brake actuation mechanism of the elevator car, controller initiating movement of the safety brake actuation mechanism to actuate a safety brake when the overall speed reading meets a predetermined speed.

15. The method of claim 14, wherein the controller is in operative communication with at least one additional safety brake actuation mechanism of the elevator car, the controller initiating movement of the at least one additional safety brake actuation mechanism when the overall speed reading meets the predetermined speed.

16. The brake assembly of any of the preceding claims, wherein the first condition reading and the second condition reading are averaged to determine the overall condition reading.
